(19) United States
(12) Patent Application Publication
(10) Pub. No.: US 2015/0149913 A1
(43) Pub. Date: May 28, 2015

(54) SYSTEM AND METHOD FOR GROUPING AND MANAGING CONCURRENTLY A PLURALITY OF SERVERS

(71) Applicants: INVENTEC (PUDONG) TECHNOLOGY CORPORATION, Shanghai (CN); INVENTEC CORPORATION, Taipei (TW)

(72) Inventors: Long CHEN, Shanghai (CN); Gang Fan, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/246,994

(22) Filed: Apr. 7, 2014

(30) Foreign Application Priority Data
Nov. 22, 2013 (CN) 201310597999.8

(51) Int. Cl. H04L 12/24

(52) U.S. Cl. CPC H04L 41/02
USPC 715/736

(57) ABSTRACT

A system and method for grouping and managing concurrently a plurality of servers are disclosed, in which a target instruction is issued to one or more servers in the same group, and all the servers are regrouped according to execution results generated by executing the target instruction on the servers in the corresponding group, where solving the issue existing in the prior art and promoting a technical efficacy of management efficiency of multiple servers.

### BACKGROUND OF THE RELATED ART

1. Technical Field

The present invention relates to a server management system and method, and particularly to a server management system and method where multiple serves are grouped and managed concurrently.

2. Related Art

Presently, a server management software typically provides a graphical user interface (GUI) for operation of a manager. To let the manager manage the server swiftly, the server management software usually provides a command line interface (CLI) to the manager so that he/she may issue a command at a remote end. For example, the server management software may provide the user to control a remote server by using a telnet protocol.

However, no matter the interface is a GUI or a CLI is used, the manager may issue the command onto only one single server at the same time for the currently technology, and the manager cannot control multiple servers at the same time Therefore, the current resolution is drafting instructions to be issued to the servers as a batch processing script, and executing the batch processing script by the server management software.

However, although the batch processing script may achieve in the result of managing concurrently multiple servers, it may be required that a script comprising a solution for some exceptional processes has to be drafted even through these exceptional cases only have a very small occurrence possibility. In addition, the use of the batch processing script has to be verified to see if the result may meet up with what has been predicted through some verification means. For the manager, the burden of the additional processing may be also large as that of issuing the commands to the servers one by one.

In view of the above, it may be known that there has long been the issue of controlling readily multiple servers at the same time, and thus it is quite a need to provide a technical means to get improved on this issue.

### SUMMARY

In view of the issue encountered in the prior art of controlling readily multiple servers at the same time, the present invention discloses a system and for grouping and managing concurrently a plurality of servers.

According to the present invention, the system for grouping and managing concurrently a plurality of servers comprises a grouping module, grouping the servers into at least one classification set, the classification sets each having its at least one classification servers; an input module, providing an input of a target instruction corresponding to one of the classification sets; and an instruction preprocessing module, transmitting the target instruction to all the classification servers of the classification set corresponding to the target instruction, wherein the grouping module further receives execution results generated after the target instruction is executed by each of the classification servers receiving the target instruction, and regrouping the servers according to the execution results.

According to the present invention, the method for grouping and managing concurrently a plurality of servers, comprising steps of grouping the plurality of servers into at least one classification set, the classification sets each having its at least one classification servers; providing an input of a target instruction corresponding to one of the classification sets; transmitting the target instruction to all the classification servers of the classification set corresponding to the target instruction; receiving execution results generated after the target instruction is executed by each of the classification servers receiving the target instruction; and regrouping the servers according to the execution results.

The system and method of the present invention has the difference as compared to the prior art that a target instruction is issued to one or more servers in the same group, and all the servers are regrouped according to the execution result generated by executing the target instruction on the servers in the corresponding group, where solving the issue existing in the prior art and promoting a technical efficacy of management efficiency of multiple servers.

### BRIEF DESCRIPTION OF THE DRAWINGS

The invention will become more fully understood from the detailed description given herein below illustration only, and thus is not limitative of the present invention, and wherein:

FIG. 1 is a systematic architecture diagram of a system for grouping and managing concurrently a plurality of servers according to the present invention;

FIG. 2A and FIG. 2B are a flowchart of a method for grouping and managing concurrently a. plurality of servers according to the present invention, respectively;

### DETAILED DESCRIPTION

The present invention will be apparent from the following detailed description, which proceeds with reference to the accompanying drawings, wherein the same references relate to the same elements.

In this invention, a target instruction inputted by a user is issued to each server in the same group corresponding to the target instruction, and all the servers are regrouped according to execution results generated by the servers executing the target instruction. In addition, the present invention may also provide the user to increase or delete the server(s) in each group.

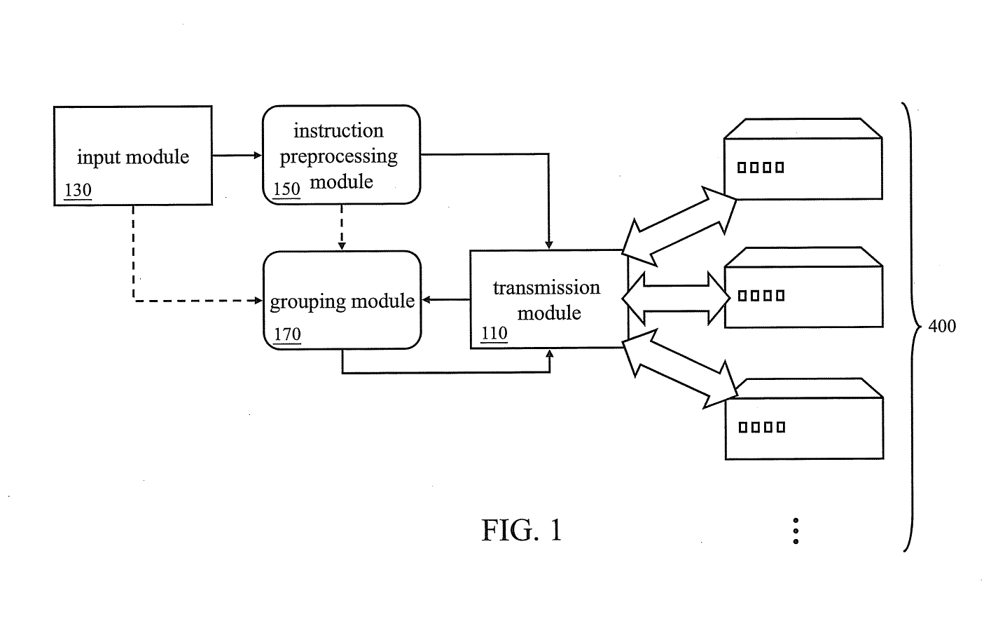

Referring first to FIG. 1, in which a systematic architecture diagram of a system for grouping and managing concurrently a plurality of servers according to the present invention is shown to explain how the system of the present invention is operated. As shown, the system comprises a transmission module 110, an input module 130, an instruction preprocessing module 150 and a grouping module 170.

The transmission module 110 exchanges information with the server 400. Generally, the transmission module 110 may establish a connection with the server 400 by using a protocol such as Telnet, SSH (secure shell), and RDC (remote desktop connection) and exchange information with the server 400 connected with itself. However, the connection establishment is not only limited to this example.

The input module 130 is used for input of a target instruction. Generally, the target instruction inputted by the input module 130 corresponds to one or more classification sets grouped by the grouping module 170. As far as the target instruction in this invention is concerned, it refers to an instruction which may perform a particular process after being executed.

In some embodiments, the input module 130 may also provide a grouping message. Generally, the inputting nodule 130 may provide a server selection interface comprising a list including all the servers, so that one or more servers desired to be grouped into the same classification set may be selected or inputted on the server selection interface. However, this is only an example, without limiting the present invention.

The instruction preprocessing module 150 transmits the target instruction inputted from the input module 130 to one or more servers 400, so that each of the servers having received the target instruction may execute the target instruction inputted from the input module 130.

Since the target instruction corresponds to one or more of the classification sets made by the grouping module 170, the instruction preprocessing module 150 may only transmit the target instruction to the server(s) 400 in each of the classification sets corresponding to the target instruction.

In some embodiments, not all the target instructions are transmitted to the server 400. The instruction preprocessing module 150 may determine if the target instruction has to be transmitted to the server 400. If yes, the target instruction is transmitted to the server 400. Otherwise, the instruction preprocessing module 150 may directly execute the target instruction. For example, the instruction preprocessing module 150 may determine if the target instruction represents deleting one ore more particular classification sets, or determine if the target instruction represents adding a new classification set. When the target instruction represents deleting a classification set, the instruction preprocessing module 150 may delete the classification set corresponding to the target instruction, or may delete a vertical relationship between the classification set corresponding to the target instruction and the server 400 in the classification set corresponding to the target instruction. On the other hand, when the target instruction represents adding a new classification set, the instruction preprocessing module 150 may establish a new classification set, and group the one ore more servers 400 into the new classification set.

The grouping 170 is used to group the servers. This grouping policy may be grouped according to the grouping message, and directly group all the servers 400 into the same classification set. The grouping message for grouping of the grouping module 170 is a default list by the system, a list which may be selected by the user on a sever selection interface, or a pre-established list, without any limitation to the present invention.

The grouping module 170 receives one or more execution results generated by the server 400 through the transmission module 110. The execution result received by the grouping module 170 is generated after the server, which receives the target instruction transmitted from the preprocessing module 150, executes the received target instruction

The grouping module 170 is also used to regroup the servers according to the execution results. Generally, the grouping module 170 may group the servers having the same execution result into the same classification set, i.e. the servers having the different execution results are grouped into different classification sets.

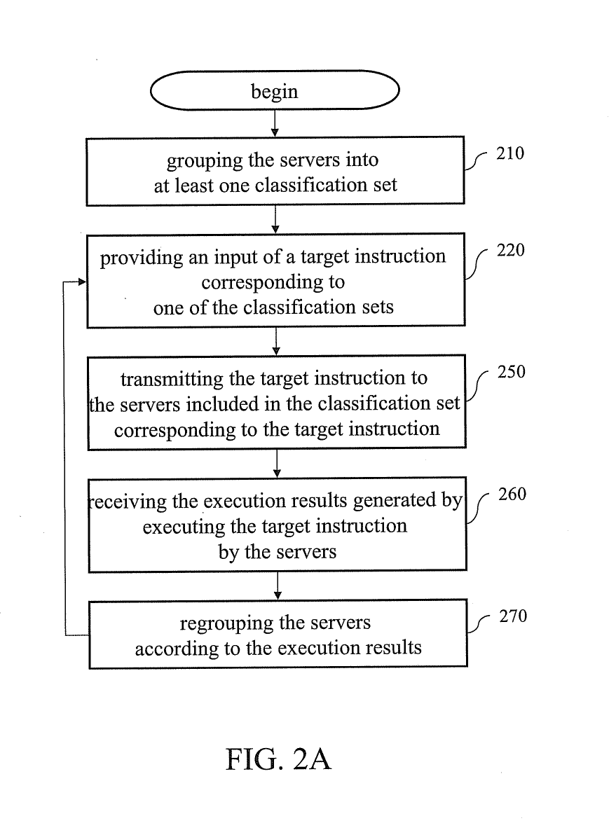

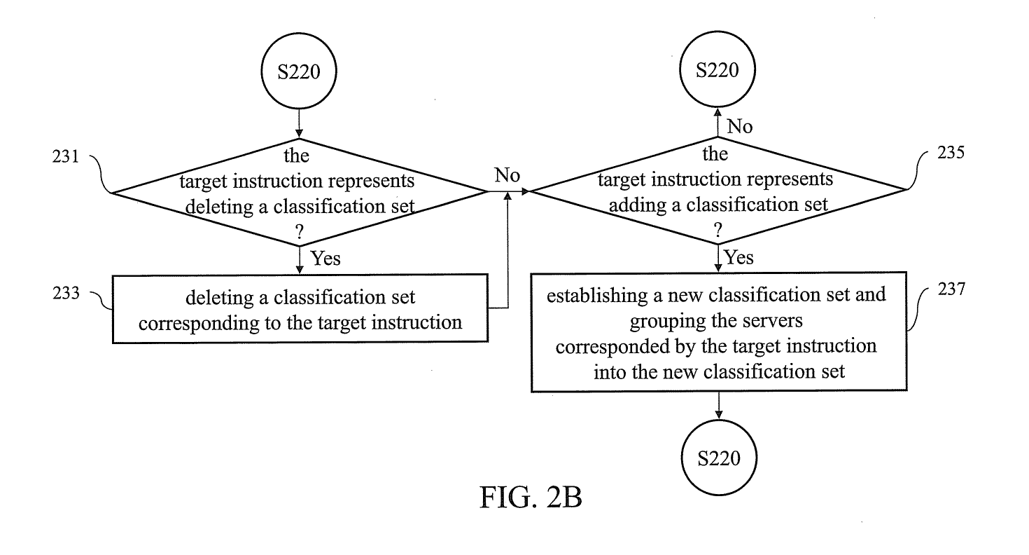

Next, an embodiment is set forth to explain how the system and method of the present invention are operated, with reference to FIG. 2A simultaneously, in which a flowchart of a method for grouping and managing concurrently a plurality of servers according to the present invention is shown. In this embodiment, the present invention is included in the server management software, but which is only an example without limiting the present invention.

At first, the grouping module 170 may group the servers 400. Generally, the grouping module 170 may group all the servers 400 into the same classification set after the present invention is executed (S210). However, the grouping module 170 may also, in real implementation, group all the servers 400 into a corresponding classification set according to the grouping message.

After grouping the servers 400 by the grouping module 170, the input module 130 may provide a user interface for input of the target instruction. In this embodiment, assume the input module 130 may provide a management command line interface (MCLI), so that the user may input the target instruction through the MCLI. However, in real implementation, the input module 130 may also provide a graphical user interface (GUI), on which the user may input the target instruction through the GUI.

Thereafter, the grouping module 170 may display all the classification sets and the servers 400 as grouped into the corresponding classification sets on the MCLI. In this embodiment, assume the grouping module 170 groups all the servers 400 in the same classification set as default. Namely, if the user has to manage four servers, the first to the fourth servers, the four servers are all grouped into a first classification set. Thus, the input module 130 may display “the first classification set: server A, server B, server C, server D”.

After the grouping module 170 displays the classification sets and the servers 400 included in the corresponding classification sets, the input module 130 may provide the user to input a target instruction corresponding to one or more classification sets (S220). In this embodiment, since there is only one classification set currently, the instruction preprocessing module 150 may determine at this time that the target instruction as inputted by the user corresponds to the first classification set.

After the target instruction is inputted by the input module 130, the instruction preprocessing module 150 may transmit the inputted target instruction through the transmission module 110 to the servers 400 included in the classification set corresponding to the target instruction, so that the server 400 included in the corresponding classification set transmitted the target instruction by the transmission module 110 executes the target instruction upon receiving it (S250). In this embodiment, since the target instruction corresponds to the first classification set including four severs, the target instruction is transmitted to all the servers to be executed through the transmission module 110 by the instruction preprocessing module 150. Assume the transmission module 110 is connected to the server 400 by using the Telnet protocol.

After the instruction preprocessing module 150 transmits the target instruction to the servers 400 included in the classification set corresponding to the target instruction and then the servers 400 execute the target instruction (S250), the grouping module 170 may receive execution results generated by executing the target instruction by the servers 400 through the transmission module 110 (S260). At this time, since most of the servers may generate the same execution result with respect to the same target instruction. Therefore, the user may issue the same instruction to multiple servers concurrently, whereby promoting the efficiency for managing the multiple servers.

After the grouping module 170 receives the execution results generated by each of the servers 400 executing the target instruction (S260), the grouping module 170 may regroup the servers 400 according to the execution results generated and received by the servers 400 (S270), and display the result of the new classification sets after regrouping on the MCLI. In this embodiment, if there are three servers having the same execution result, and servers A, B and C are assumed as the three servers while server D is assumed as having a different execution result, the grouping module 170 may group servers A, B and C into the first classification set and server D into a second classification set. However, in real implementation, the grouping module 170 may also group servers A, B and C having the same execution result into the second classification set, while server D into the first classification set. If the execution results generated server A and server B are the same, and the execution results generated server C and server D are the same, but the execution results generated server AB and server C/D are different, the grouping module 170 may group servers A and B into the first classification set and servers C and D into a second classification set.

After the grouping module 170 displays the result of the new classification sets on the MCLI, the input module 130 may provide the user to further input a new target instruction (S220). In this embodiment, assume the input module 130 displays the result, such as “the first classification set: server A, server B, server; the second classification set: server D”, on the MCLI. If the user continues to input the new target instruction on MCLI, and the target instruction does not mean switching the current classification set (the first classification set) to another classification set (the second classification set), the instruction preprocessing module 150 may determine the target instruction inputted by the user as corresponding to the first classification set since the target instruction inputted last time by the user is corresponding to the first classification set. Thus, the instruction preprocessing module 150 may process the target instruction accordingly, for example, the instruction preprocessing module 150 transmits the target instruction to the servers included in the first classification set through the transmission module 110, i.e. the target instruction is transmitted to servers A, B and C for execution (S250).

Thereafter, the grouping module 170 may receive the execution results transmitted by the servers A, B and C after executing the target instruction through the transmission module 110 (S260) and regroup servers A, B and C according to the received execution results (S270). In this embodiment, assume the execution results generated by servers A, B and C are the same, and the grouping module 170 keeps on the servers A, B and C in the same classification set. If the execution results generated by servers A, B and C are all different, the grouping module 170 may regroup the servers A, B and C in different classification sets. In this way, there are four the classification sets.

In the above embodiment, when the instruction preprocessing module 150 processes the target instruction, if the target instruction inputted by the user at the second time is not the one transmitted to the server 400 for execution, the instruction preprocessing module 150 may directly execute the target instruction inputted by the user. For example, a target instruction setting a classification set corresponding to a subsequent target instruction transmitted to the servers included in the set classification set, a target instruction deleting/adding one or more classification sets, a target instruction adding/deleting one or more of the severs including a particular classification set, or a target instruction moving one or more particular classification sets to other MCLI (session).

The instruction preprocessing module 150 may act as that shown in FIG. 2B to determine if the target instruction represents deleting/adding a classification set (S231, 235), adding/deleting a server from a particular classification set, switching the current classification set to another classification set transmitted a subsequent target instruction, or moving a particular classification set to other MCLI, after the input module 130 provides the user to input the target instruction (S220). If yes, the instruction preprocessing module 150 may delete the classification set corresponding to the target instruction (S233), establish a new classification set and group one and more servers corresponded by the target instruction into the new classification set (S237), deleting a server from a particular classification set, grouping a particular server into a particular classification set, switching the current classification set, or moving a particular classification set to other MCLI, etc.

In view of the above, it may be known that the system and method of the present invention has the difference as compared to the prior art that a target instruction is issued to one or more servers in the same group corresponding to the target instruction, and all the servers are regrouped according to the execution results generated by the servers executing the target instruction, where solving the issue existing in the prior art where multiple servers are not easily controlled concurrently and promoting a technical efficacy of management efficiency of multiple servers.

Furthermore, the system and method for grouping and managing concurrently a plurality of servers according to the present invention may be implemented in hardware, software or a combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for grouping and managing concurrently a plurality of servers, comprising steps of:
grouping the servers into at least one classification set, the classification sets each having its at least one classification servers;
providing an input of a target instruction corresponding to one of the classification sets;
transmitting the target instruction to all the classification servers of the classification set corresponding to the target instruction;
receiving execution results generated after the target instruction is executed by each of the classification servers receiving the target instructio; and regrouping the servers according to the execution results.

2. The method as claimed in claim 1, wherein the steps of grouping the servers into the classification sets further comprises a step of grouping the servers into the classification sets according to a grouping message providing an input.

3. The method as claimed in claim 1, wherein the steps of grouping the servers into the classification sets further comprises a step of grouping the servers into the classification sets according to a grouping message inputted previously.

4. The method as claimed in claim 1, wherein the steps of grouping the servers into the classification sets further comprises a step of grouping all of the servers into one classification set.

5. The method as claimed in claim 1, further comprising a step of deleting one of the classification sets corresponding to the target instruction when the target instruction is determined as being deletion one of the classification sets, after the step of providing the input of the target instruction corresponding to the classification set.

6. The method as claimed in claim 1, further comprising a step of establishing a new classification set corresponding to the target instruction and grouping at least one of the servers corresponding to the target instruction into the new classification set when the target instruction is determined as being an addition of the new classification set, after the step of providing the input of the target instruction corresponding to the classification set.

7. The method as claimed in claim 1, wherein the step of regrouping the servers according to the execution results further comprises a step of grouping at least one of the servers corresponding to the same execution results into the same one classification set.

8. A system for grouping and managing concurrently a plurality of servers, comprising:
a grouping module, grouping the servers into at least one classification set, the classification sets each having its at least one classification servers;
an input module, providing an input of a target instruction corresponding to one of the classification sets; and
an instruction preprocessing module, transmitting the target instruction to all the classification servers of the classification set corresponding to the target instruction,
wherein the grouping module further receives execution results generated after the target instruction is executed by each of the classification servers receiving the target instruction, and regrouping the servers according to the execution results.

9. The system as claimed in claim 8, wherein the grouping module groups the servers into the classification set according to a grouping message providing an input by the input module.

10. The system as claimed in claim 8, wherein the grouping module groups the servers into the classification set according to a grouping message set up previously.

11. The system as claimed in claim 8, wherein the grouping module grouping all of the plurality of servers into one classification set.

12. The system as claimed in claim 8, wherein the instruction preprocessing module further deletes one of the classification sets corresponding to the target instruction when the target instruction is determined as being deletion of one of the classification sets.

13. The system as claimed in claim 8, wherein the instruction preprocessing module further establishes a new classification set corresponding to the target instruction and groups at least one of the servers corresponding to the target instruction into the new classification set when the target instruction is determined as being an addition of the new classification set.

14. The system as claimed in claim 8, wherein the grouping module groups at least one of the servers corresponding to the same execution results into a same one classification set.
